(19) United States
(12) Patent Application Publication
(10) Pub. No.: US 2005/0131835 A1
(43) Pub. Date: Jun. 16, 2005

(54) System for pre-trusting of applications for firewall implementations

(76) Inventor: James A. Howell JR., Georgetown, TX (US)

Correspondence Address: HAMILTON & TERRILE, LLP, P.O. BOX 203518, AUSTIN, TX, 78720, US

(21) Appl. No.: 10/734,840

(22) Filed: Dec. 12, 2003

(51) Int. Cl. G06F 17/60

(52) U.S. Cl. 705/64

(57) ABSTRACT

A system which dynamically generates a list of applications on an individual machine that a firewall application should enable access to the internet by default is provided. The list is generated via registering applications during factory installation. Firewall applications scan this list of registered applications during the installation or setup of the firewall application and add all applications in the list to the list of default trusted applications.

### BACKGROUND OF THE INVENTION

1. Field of the Invention

The present invention relates to build to order systems, and more particularly, managing subscription service purchases in build to order systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more information handling systems, data storage systems, and networking systems.

It is known to install software and to perform tests on information handling systems before they are shipped to businesses or individual customers. A goal of software installation is to efficiently produce a useful, reliable information handling system. Software installation often includes loading a desired package of software onto the information handling system, preparing appropriate environment variables for the information handling system, and preparing appropriate initialization files for the loaded software.

When installing hardware and software onto multiple information handling systems in a manufacturing environment, one issue relates to installing firewall software onto the multiple information handling systems.

Known firewall software includes application level checks whenever an application requests access to the internet. Many known firewall implementations allow a user to grant or block access to the internet by a given application. For security reasons, simply adding file names to a default approved application list is generally not permitted by the firewall software. Some form of additional authentication is performed to assure that the application has not been modified from its original form. One form that this additional authentication has taken is generating a unique application identifier, such as a checksum, that uniquely identifies a particular application. For example, known firewall applications use an MD5 signature as a checksum which is used by the firewall application to determine whether an application in the firewall application database has changed.

One challenge associated with pre-installing firewall software is that even when the firewall is configured to allow certain applications access, an application that is installed may be a different version from that identified by the firewall software provider checksum and therefore the checksum may not match what had been previously allowed. This challenge is further enhanced when an information handling system manufacturer develops its own software applications (e.g., support applications, alert applications and solution center applications) that firewall software providers do not necessarily have visibility to and cannot maintain an updated database of checksums without a great deal of manual effort.

It is desirable to address challenges associated with factory installing a firewall application in a dynamic build to order environment. For example, customers may not appreciate why they are prompted when an application requests access to the internet, so they may block the application request and thus deny their system access to the internet. Additionally, customers may block access to the internet of manufacturer specific applications that actually increase the security of the system such as support applications and alert applications.

### SUMMARY OF THE INVENTION

In accordance with the present invention, a system which dynamically generates a list of applications on an individual machine that a firewall application should enable access to the internet by default is provided. The system includes an assumption that applications installed during the factory install process are safe and have not had a chance to be modified by a Trojan since the machine has not yet been connected to the internet. The list is generated via registering applications during factory installation and expecting firewall application providers to scan this list of registered applications during the installation or setup of the firewall application and to add all applications in the list to the list of default trusted applications.

Such a system advantageously provides a seamless customer experience when operating an information handling system with preinstalled firewall software. Such a system also advantageously provides a customer with access to the firewall application without having to make decisions that are unnecessary for the security of the system.

One embodiment of the invention relates to a method for pre-trusting applications for a firewall application. The method includes reading an order for an information handling system, installing a software application onto the information handling system, adding an identifier for the software application to a list of trusted applications, installing the firewall application onto the information handling system, and accessing the list of trusted applications to automatically identify to the firewall application that the software application is a trusted application.

In another embodiment, the invention relates to an apparatus for pre-trusting applications for a firewall application. The apparatus includes means for reading an order for an information handling system, means for installing a software application onto the information handling system, means for adding an identifier for the software application to a list of trusted applications, means for installing the firewall application onto the information handling system, and means for accessing the list of trusted applications to automatically identify to the firewall application that the software application is a trusted application.

In yet another embodiment, the invention relates to an information handling system which includes a processor, memory coupled to the processor, a firewall application stored on the memory, and an approved application file stored on the memory. The approved application file includes a list of trusted applications. The firewall application accesses the list of trusted applications to automatically identify a software application as a trusted software application.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a schematic block diagram of an information handling system having a firewall application prequalification system.

FIG. 3 shows a flow chart of the operation of a trusted application update process.

FIG. 4 shows a flow chart of the operation of an alternate trusted application update process.

FIG. 5 shows a flow chart of the generation of the trusted application file.

### DETAILED DESCRIPTION

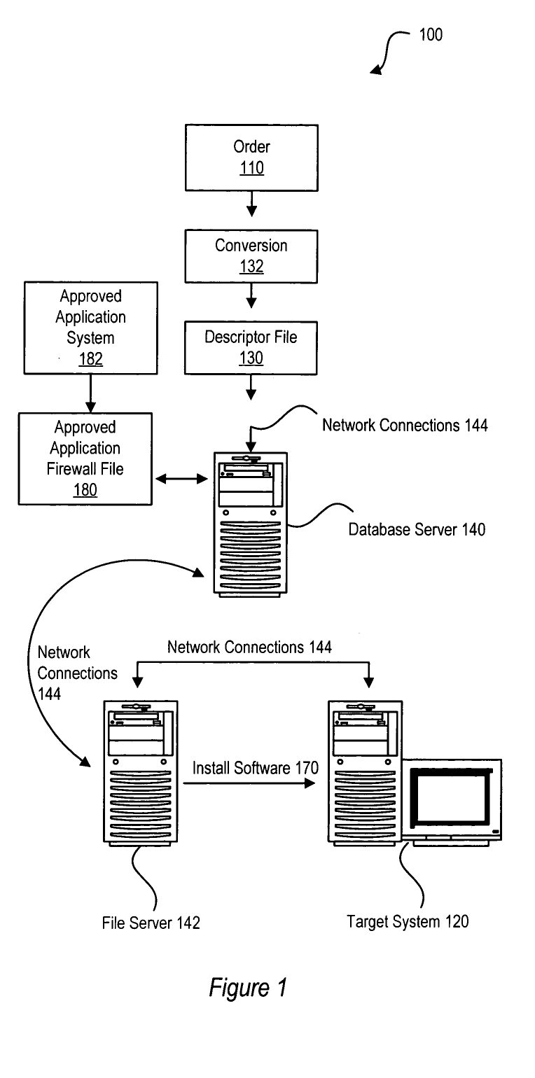

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. The software may also include firewall software. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components may require different software installations, it is desirable to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In one embodiment, the component descriptors are included in a descriptor file called a system descriptor record which is a computer readable file containing a listing of the components, both hardware and software, to be installed onto target information handling system 120. Having read the plurality of component descriptors, database server 140 provides an image having a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120 via file server 142. The software is installed on the target information handling system via the image. The image may include self-configuring code.

The database server 140 may also be provided with an approved application firewall file 180. The approved application firewall file 180 identifies to the installed firewall software a list of those applications that are installed during the manufacture of the target system 120 and are thus presumed safe from the standpoint of the firewall software.

An approved application system 182 dynamically generates the approved application firewall file 180 based upon applications that are to be installed on an individual target system 120. The applications that are to be installed may be derived from the descriptor file 130. Thus, the approved application firewall file 180 sets forth applications that a firewall application should enable access to the internet by default. The system 182 includes the assumption that applications installed during the factory install process are safe and have not had a chance to be modified by a Trojan since the machine has not yet been connected to the internet.

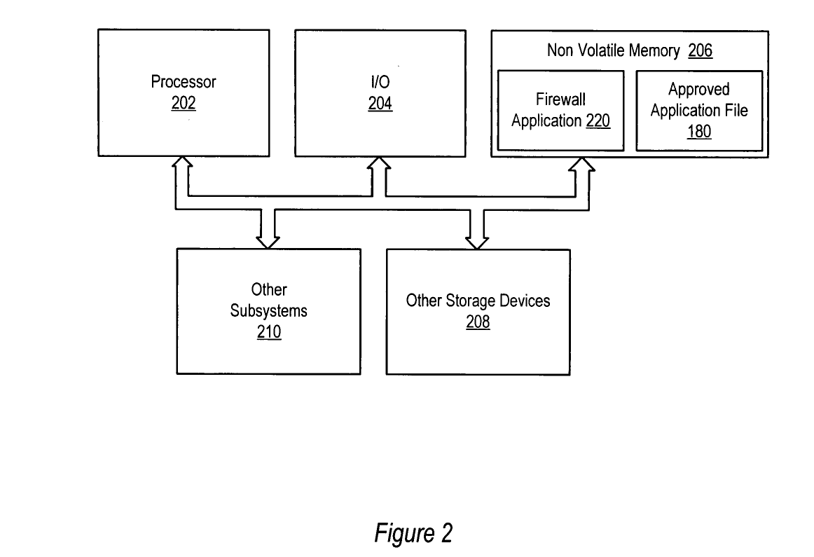

Referring to FIG. 2, a system block diagram of a target information handling system 120 which includes firewall software as well as an approved application file 180 is shown. The information handling system includes a processor 202, input/output (I/O) devices 204, such as a display, a keyboard, a mouse, and associated controllers, a non-volatile memory 206 such as a hard disk drive, and other storage devices 208, such as a floppy disk and drive and other memory devices, and various other subsystems 210, all interconnected via one or more buses 212. The non volatile memory includes firewall application software 220 as well as the approved application file 180 for the target system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

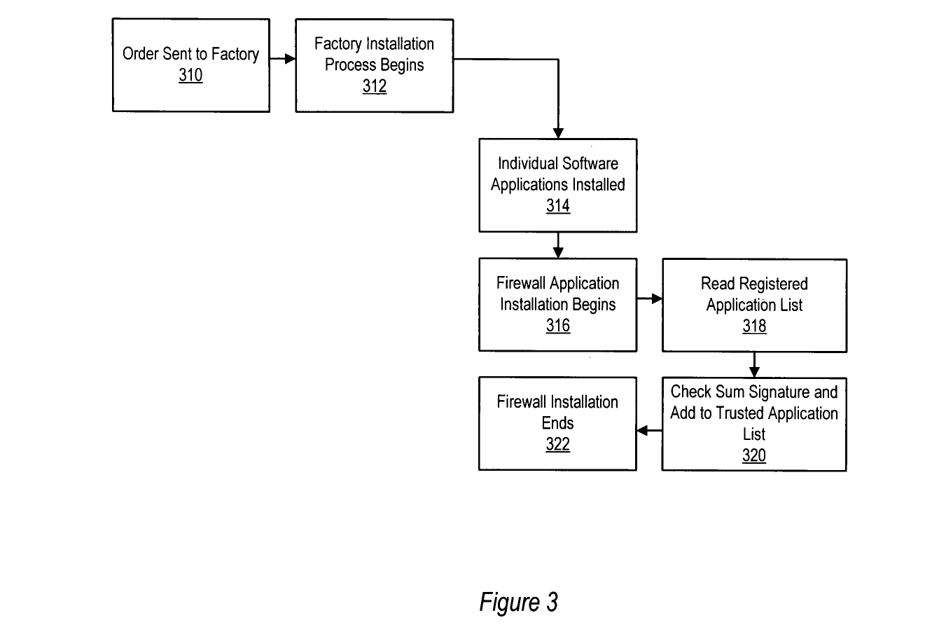

Referring to FIG. 3, a flow chart of the operation of a trusted application update process is shown. More specifically, the trusted application update process begins when an order 110 is sent to the factory which includes firewall software 220 selected during the purchase of the target system 120 at step 310. Next, the factory installation process begins at step 312. Individual software applications are installed onto the target system 120 and registered for inclusion as trusted applications at step 314. Next, the firewall software application installation begins at step 316. The firewall software 220 reads the registered application list 180 at step 318. The firewall software 220 generates a checksum for each of the applications on the registered application list and adds these checksums to the trusted application list for the firewall at step 320. In one embodiment, the checksum may correspond to an MD5 signature. The firewall software installation completes at step 322.

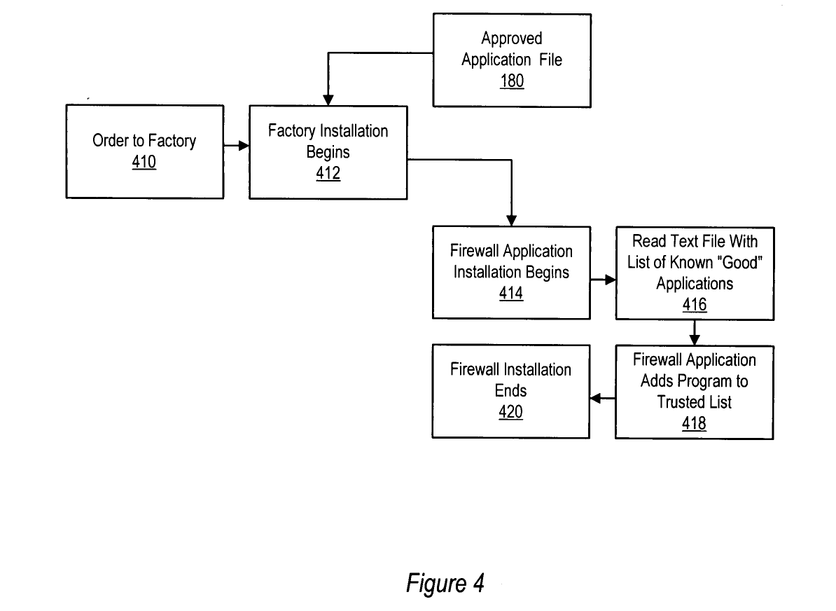

Referring to FIG. 4, a flow chart of the operation of an alternate trusted application update process is shown. More specifically, the trusted application update process begins when an order 110 is sent to the factory which includes firewall software 220 selected during the purchase of the target system 120 at step 410. Next, the factory installation process begins at step 412 during which individual software applications are installed onto the target system 120. The file 180 is installed during the factory installation process of step 412. Next, the firewall software application installation begins at step 416. The firewall software 220 reads the registered application list 180 at step 418. The firewall software 220 generates a checksum for each of the applications on the registered application list and adds these checksums to the trusted application list for the firewall at step 420. In one embodiment, the checksum may correspond to an MD5 signature. The firewall software installation completes at step 422.

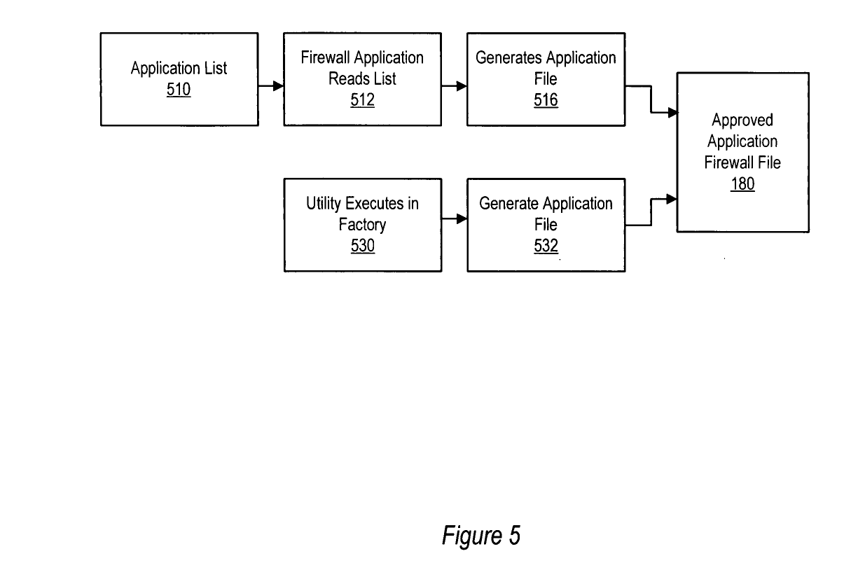

Referring to FIG. 5, a flow chart of the generation of the trusted application file is shown. More specifically, during installation, applications add information to an application list at step 510. The firewall software 220 then reads this application list during the installation of the firewall software at step 514. The firewall software 220 then generates the application file at step 516.

Alternately, a utility module may execute within the factory at step 530. The utility module determines which applications have been installed on the target system 120. The utility module may determine which applications were installed on the target system 120 by analyzing the system descriptor record of the target information handling system 120. The utility module then generates the application file 180 at step 532.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the list within the approved application file may be generated by registering applications during factory installation and expecting firewall application providers to scan this list of registered applications during the installation or setup of the firewall software and to add all applications in the list to the list of default trusted applications.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for pre-trusting applications for a firewall application, the method comprising:
reading an order for an information handling system;
installing a software application onto the information handling system;
adding an identifier for the software application to a list of trusted applications;
installing the firewall application onto the information handling system; and
accessing the list of trusted applications to automatically identify to the firewall application that the software application is a trusted application.

2. The method of claim 1 wherein:
the list of trusted applications is generated within a manufacturing facility.

3. The method of claim 2 further comprising:
generating a check sum for the software application; and,
adding the check sum to the list of trusted applications.

4. The method of claim 3 further wherein:
the check sum corresponds to an MD5 signature.

5. The method of claim 1 wherein:
the list of trusted applications is generated by the firewall application based upon a record of software that is installed on the information handling system in a manufacturing facility.

6. The method of claim 5 further comprising:
generating a check sum for the software application; and,
adding the check sum to the list of trusted applications.

7. The method of claim 6 further wherein:
the check sum corresponds to an MD5 signature.

8. An apparatus for pre-trusting applications for a firewall application, the method comprising:
means for reading an order for an information handling system;
means for installing a software application onto the information handling system;
means for adding an identifier for the software application to a list of trusted applications;
means for installing the firewall application onto the information handling system; and
means for accessing the list of trusted applications to automatically identify to the firewall application that the software application is a trusted application.

9. The apparatus of claim 8 wherein:
the list of trusted applications is generated within a manufacturing facility.

10. The apparatus of claim 9 further comprising:
means for generating a check sum for the software application; and,
means for adding the check sum to the list of trusted applications.

11. The apparatus of claim 10 further wherein:
the check sum corresponds to an MD5 signature.

12. The apparatus of claim 8 wherein:
the list of trusted applications is generated by the firewall application based upon a record of software that is installed on the information handling system in a manufacturing facility.

13. The apparatus of claim 12 further comprising:
means for generating a check sum for the software application; and,
means for adding the check sum to the list of trusted applications.

14. The apparatus of claim 13 further wherein:
the check sum corresponds to an MD5 signature.

15. An information handling system comprising:
a processor;
memory coupled to the processor;
a firewall application stored on the memory;
an approved application file stored on the memory, the approved application file including a list of trusted applications, the firewall application accessing the list of trusted applications to automatically identify a software application as a trusted software application.

16. The information handling system of claim 15 wherein:
the list of trusted applications is generated within a manufacturing facility.

17. The information handling system of claim 15 wherein:
the list of trusted applications is generated by the firewall application based upon a record of software that is installed on the information handling system in a manufacturing facility.
